(19) United States
(12) Patent Application Publication
(10) Pub. No.: US 2022/0048646 A1
(43) Pub. Date: Feb. 17, 2022

(54) Multipurpose Autonomous Material Handling Robot with Independent Drones

(71) Applicant: Accelerated Systems Inc., Waterloo (CA)

(72) Inventors: Peter Mankowski, Cambridge (CA); Willem Jager, Cambridge (CA)

(21) Appl. No.: 17/401,381

(22) Filed: Aug. 13, 2021

Related U.S. Application Data
(60) Provisional application No. 63/065,572, filed on Aug. 14, 2020.

(51) Int. Cl. B64F 1/36; B64C 39/02; B64F 1/04; B64F 1/22; B64F 1/32; B64D 47/08; B64F 1/12

(52) U.S. Cl. CPC B64F 1/364; B64C 39/024; B64F 1/04; B64F 1/22; B64F 1/32; B64C 2201/208; B64F 1/12; B64C 2201/027; B64C 2201/08; B64C 2201/108; B64C 2201/127; B64D 47/08

(57) ABSTRACT

A material handling robot including a mobile base, a plurality of drones, and a plurality of docking stations on the mobile base for receiving the drones. The mobile base has motorized wheels for driving the mobile base, and a platform for supporting a load. Each drone has a power source and a drone sensor for monitoring environment around the drone. Each docking station has a power charger for recharging the power source, and a launch mechanism for deploying the drone. The robot also includes a controller for communicating with the mobile base and the drones. The controller has: a material handling mode for transporting loads on the platform of the mobile base; and a security mode where at least one of the drones is deployed to conduct surveillance using the drone sensor.

### RELATED APPLICATIONS

This application claims priority to U.S. Provisional App. No. 63/065,572, filed Aug. 14, 2020 and entitled “Multipurpose Autonomous Material Handling Robot with Independent Drones”, the entire contents of which are hereby incorporated by reference herein for all purposes.

### TECHNICAL FIELD

The embodiments herein relate to material handling robots for use in industrial environments. More particularly, the embodiments herein relate to a mobile material handling robot with independent drones for performing multiple functions in an industrial environment, such as a factory or a warehouse.

### INTRODUCTION

The following paragraphs are not an admission that anything discussed in them is prior art or part of the knowledge of persons skilled in the art.

Robots are often used within industrial environments to complete specific tasks. In some cases, these robots are only used during specific times of the day. When not in use, the robot sits idle. For example, material handling robots are often used during a work shift to transport goods and other materials between locations. When the warehouse closes, the robots may be turned off until the next work shift. This downtime limits overall utilization for the robot and can limit cost effectiveness.

### SUMMARY

One general aspect includes a material handling robot including a mobile base, a plurality of drones, and a plurality of docking stations on the mobile base for receiving the drones. The mobile base has motorized wheels for driving the mobile base, and a platform for supporting a load. Each drone has a power source and a drone sensor for monitoring environment around the drone. Each docking station has a power charger for recharging the power source, and a launch mechanism for deploying the drone. The robot also includes a controller for communicating with the mobile base and the drones. The controller has: a material handling mode for transporting loads on the platform of the mobile base; and a security mode where at least one of the drones is deployed to conduct surveillance using the drone sensor.

Implementations may include one or more of the following features.

The drone sensor may include a thermal camera and an optical camera. The thermal camera may be activated during the material handling mode to detect temperature increases on warehouse equipment, and may generate an alert for preventative maintenance based on the temperature increases.

Each docking station may include a magnetic coupling for holding the drone on the docking station. The magnetic coupling may be an electromagnet. The electromagnet may be activated while the power charger is recharging the power source of the drone. The launch mechanism may have a spring-loaded launcher, and the magnetic coupling may compress the spring-loaded launcher when the drone is docked. The spring-loaded launcher may include a compressed air piston.

The power charger includes a wireless fast charger. Each drone may be a quadcopter. The controller may operate a nano-network for selectively deploying one of the drones based on a specific task, and power requirements for the specific task.

Implementations of the described techniques may include hardware, a method or process, or computer software on a computer-accessible medium. Other embodiments include corresponding computer systems, apparatus, and computer programs recorded on one or more computer storage devices, each configured to perform the actions of the methods.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a perspective view of a material handling robot having a mobile base and a plurality of independent drones;

FIG. 2 is a front elevational view of the material handling robot of FIG. 1 showing a drone taking off;

FIG. 3 is a rear elevational view of the material handling robot of FIG. 1;

FIG. 4 is a right-side elevational view of the material handling robot of FIG. 1;

FIG. 5 is a left-side elevational view of the material handling robot of FIG. 1;

FIG. 6 is a top plan view of the material handling robot of FIG. 1; and

FIG. 7 is a schematic showing a controller in communication with the mobile base and the drones.

### DETAILED DESCRIPTION

Various apparatuses or processes will be described below to provide exemplary embodiments. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed below that is not claimed in this document may be the subject matter of another protective instrument, for example, a continuing patent application, and the applicants, inventors or owners do not intend to abandon, disclaim or dedicate to the public any such invention by its disclosure in this document.

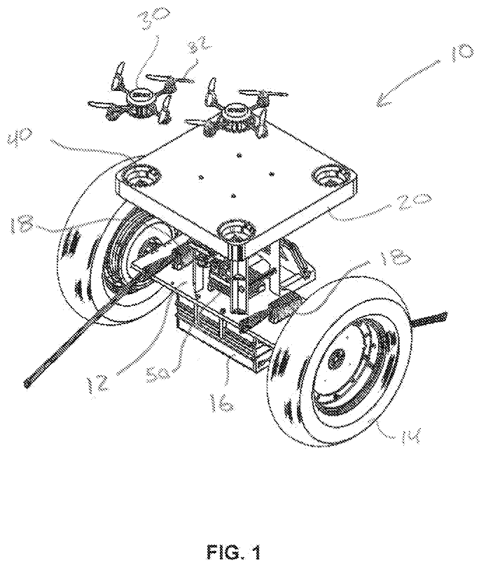

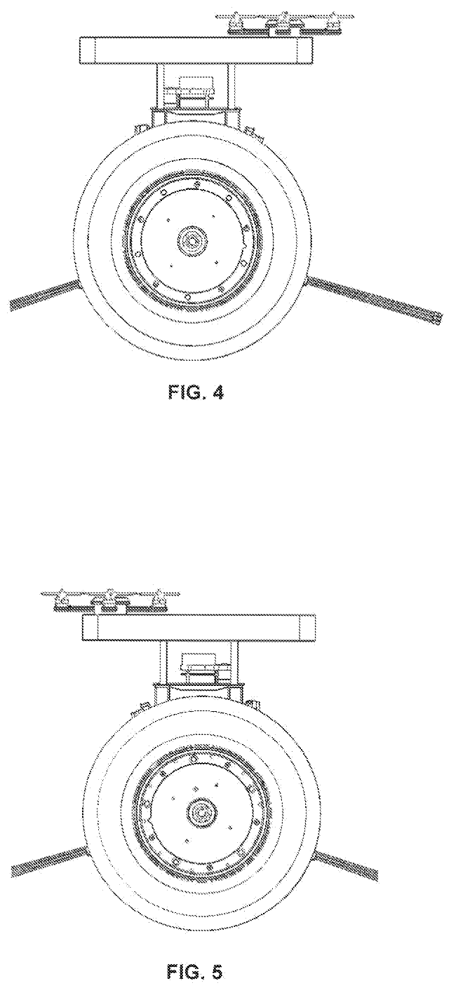

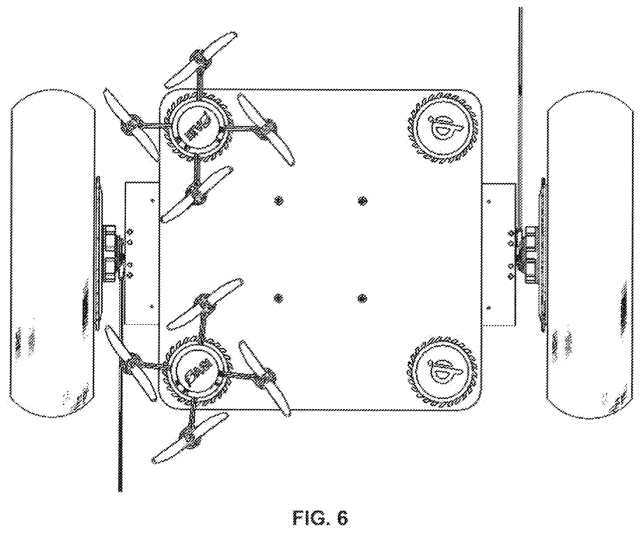

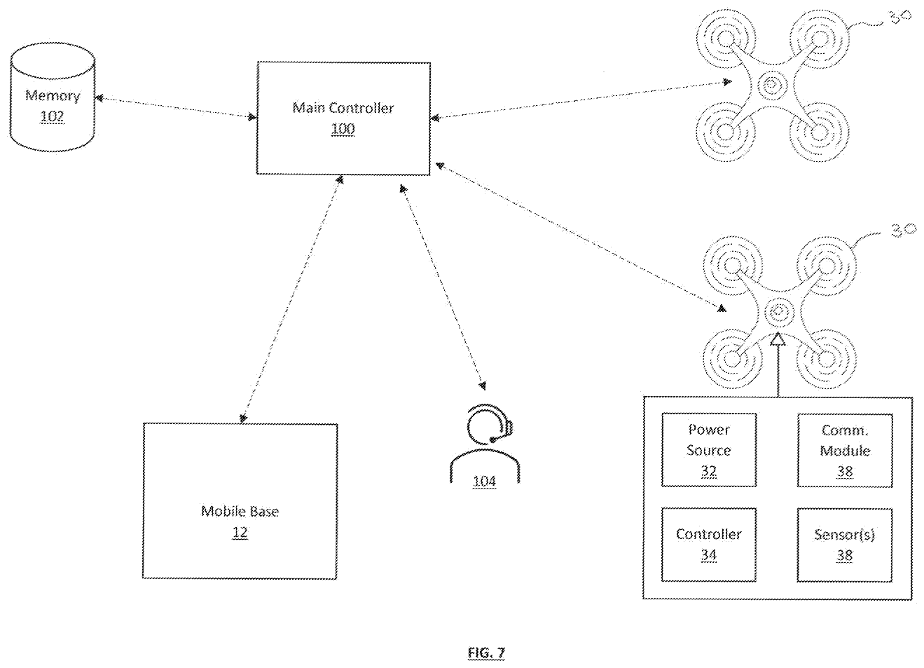

Referring to FIGS. 1-6, there is a material handling robot 10. The robot 10 may be used within an industrial environment, such as a factory or a warehouse. The robot 10 may be configured for multiple purposes. For example, during the day, the robot 10 may have a material handling mode for transporting materials or other loads within the warehouse. During the night, the robot 10 may switch to a security mode to conduct surveillance and monitor the warehouse for intruders or other disturbances.

The robot 10 includes a mobile base 12 and a plurality of drones 30. The mobile base 12 is generally used to transport loads while the robot 10 is in material handling mode. The drones 30 are generally used to conduct surveillance when the robot 10 is in the security mode. The mobile base 12 and drones 30 may have additional functions in other modes as will be described below

The mobile base 12 may have motorized wheels 14 for driving the mobile base 12. As shown, there may be two wheels 14 driven by an electronic motor connected to a main power source 16 such as a battery pack. Each wheel 14 may be independently driven by its own hub motor. This may allow motion and steering capabilities. In other embodiments, the mobile base 12 may have additional wheels, some of which may be steerable, and some of which may be driven. The mobile base 12 may have a cable assembly, which may be used for control, diagnostics, and other communications. In some examples, there may be wireless communications.

The mobile base 12 may have one or more navigational sensors 18 such as LIDAR, time-of-flight range finders, accelerometers, gyroscopes, ultrasonic sensors, infrared sensors, GPS data, other types of navigational coordinated sensors

The mobile base 12 also includes a platform 20. As shown, the platform 20 may have a flat top surface, which may be used to support a load such as goods or materials being transported within the warehouse while the robot is in the material handling mode.

The drones 30 may cooperate with the mobile base 12 to complete various tasks. The tasks may change based on the configured mode of the robot 10. For example, in material handling mode, the drones 30 may provide navigational information to the mobile base 12. As another example, the drones 30 may assist with preventative maintenance by monitoring equipment within the warehouse. In the security mode, the drones 30 may conduct surveillance.

As shown, the drones 30 may be aerial vehicles such as quadcopters. The quadcopters have four rotors capable of providing vertical lift and lateral motion. In other examples, the drones 30 may have other configurations, such as wheeled robots that travel along the ground.

Referring to FIG. 7, each drone 30 has a power source 32, which may be enclosed within the body of the drone 30. The power source 32 may be a rechargeable electric power source such as a lithium ion battery. The power source 32 generally operates the rotors and other onboard electronics, such as a drone processor 34, a drone communication module 36, and one or more drone sensors 38.

The drone sensors 38 may help to monitor the environment around the drone 30. The drone sensors 38 may include infrared sensors, thermal cameras, optical cameras, and LIDAR. The drone sensors 38 may be used selectively depending on the selected mode for the robot 10. For example, a thermal camera may be activated during the material handling mode to detect temperature increases on machinery and other equipment, which may signal wear of a component and that it is time to complete preventative maintenance. During the security mode, the thermal camera may be used to detect heat signatures from people. If someone is detected, the drone 30 may activate an optical camera to take a picture or record video of a potential intruder.

The robot 10 also includes docking stations 40 on the mobile base 12 for receiving the drones 30. The docking stations 40 may be located on the platform 20. For example, the docking stations 40 may be formed as recesses in the platform 20. The recesses may be shaped to correspond with the shape of the drone 30. This may help to securely hold the drones 30 while on the mobile base 12.

Each docking station 40 includes a power charger 42 for recharging the power source 32 on the drone 30. For example, the power charger 42 may provide wireless fast charging. The power charger 42 could also include contact pads for direct connection charging.

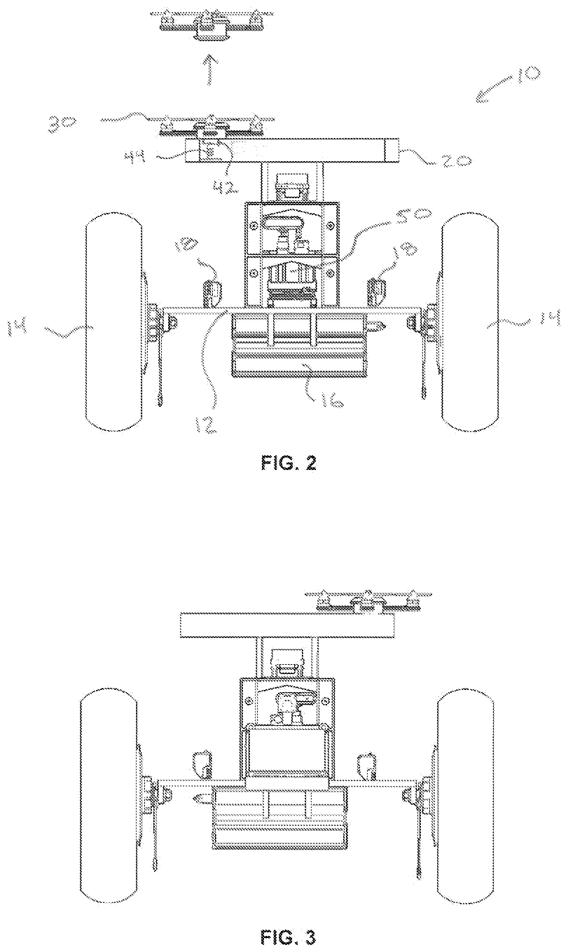

Each docking station 40 also includes a launch mechanism 44 for deploying the drone 30. For example, the launch mechanism 44 may be a spring-loaded launcher such as a coiled spring, or a compressed air piston. Once the drone 30 has been sufficiently charged and ready for deployment, the launch mechanism 44 may propel the drone 30 upwards as shown in FIG. 2. This allows for rapid deployment and can also reduce the power requirements for vertical lift-off, which might otherwise drain the power source 32 on the drone 30 during initial takeoff.

The docking station 40 may also include a magnetic coupling for biasing the drone 30 against the docking station 40. This may help secure the drone 30 to the mobile base 12 when charging or otherwise docked. In some examples, the magnetic coupling may be an electro-magnet located underneath the top surface of the platform 20. The electro-magnet may draw in a ferromagnetic mounting point on the drone such as a steel insert.

The magnetic coupling may be activated while the power charger is recharging the power source 32 of the drone 30. This may help pull the drone 30 toward the power charger 42, which may improve charging efficiency. For example, the power charger 42 may have a transmitter coil (TX) for supplying energy to a receiver coil (RX) on the drone 30. The wireless charging efficiency may increase if the transmitter coil TX and the receiver coil (RX) have proper alignment and spacing. The steel insert may have a particular shape that cooperates with the magnetic coupling to assist with proper alignment and spacing of the coils.

The magnetic coupling may also compress the spring-loaded launch mechanism 44 when the drone 30 is docked. The drone 30 may be launched be deactivating the magnetic coupling, which may release the coiled spring or compressed air piston and launch the drone 30 upward. The drone 30 may concurrently activate the rotors to begin flight.

Referring to FIG. 7, the robot 10 also includes a controller 100 for communicating with the mobile base 12 and the drones 30. As shown, the controller 100 may be located separately and communicate remotely with both the mobile base 12 and drones 30. In other examples, the controller 100 may be located on the mobile base 12 and may communicate wirelessly with the drones 30. Further still, the controller 100 may be a distributed network or a nano-network. In this example, the mobile base 12 and drones 30 may have local processors that act together as a collective controller for the robot 10. In this example, the robot 10 may still have a central processor, which may augment the local processors to handle more complex tasks.

In general, the controller 100 selectively deploys the mobile base 12 and drones 30 based on a specific task, and power requirements for the task.

For example, during the day, the controller 100 may deploy the mobile base 12 for material handling tasks. In addition, the controller 100 may selectively deploy one or more drones at a time to monitor equipment and detect rises in thermal temperature. For example, a first drone may fly to each piece of equipment being monitored and take a first set of thermal images of the equipment, such as a wheel bearing on a forklift. The thermal images may be saved in a memory storage 102 such as RAM or a network drive. The first drone 30 may then return to the mobile base 12 for charging. While the first drone 30 is charging, the robot 10 may deploy a second drone 30 to take a second set of thermal images associated the same wheel bearings or other equipment. Once multiple sets of images are collected for a specific piece of equipment, the images can be compared over time to identify rising thermal temperatures. If a rise in temperature is detect, the controller 100 may trigger a maintenance request. For example, if there is a sudden rise in temperature on the wheel bearings of the forklift, the controller 100 may trigger a preventive maintenance alert to a technician 104 who can then replace the wheel bearing before it fails.

In the example above, the preventive maintenance task can be completed by having one drone 30 deployed at a time in successive sessions. In some cases, it may be desirable to monitor multiple pieces of equipment at the same time. In such cases, the controller 100 may deploy two or more drones 30 while two or more drones remain in the docking stations 40.

As another example, the controller 100 may deploy one drone 30 at a time during the security mode. If an intruder is detected, the controller 100 may deploy additional drones 30 to the location of the intruder. This may help collect additional information or provide redundancy in the event the intruder seeks to disable one of the drones 30. The controller 100 may initiate a request for assistance from security personnel or local authorities. In addition, the controller 100 may deploy the mobile base 12 to the intruder. The mobile base 12 may collect additional information about the intruder, or act as a deterrent to scare away the intruder.

Once a task is completed, the controller 100 may recall all drones 30 in order to recharge the power sources 32 for the next task. This may help keep drones 30 on standby in case an urgent situation arises, such an intruder as described above.

In the preceding description, for purposes of explanation, numerous details are set forth in order to provide a thorough understanding of the embodiments. However, it will be apparent to one skilled in the art that these specific details may not be required. In other instances, well-known structures are shown in block diagram form in order not to obscure the understanding. For example, specific details are not provided as to whether some of the embodiments described herein are implemented as a software routine running on a processor via a memory, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. A material handling robot comprising:
a) a mobile base having:
i) motorized wheels for driving the mobile base, and
ii) a platform for supporting a load;
b) a plurality of drones, each drone having a power source and a drone sensor for monitoring environment around the drone;
c) a plurality of docking stations on the mobile base for receiving the drones, each docking station having:
i) a power charger for recharging the power source; and
ii) a launch mechanism for deploying the drone;
d) a controller for communicating with the mobile base and the drones, the controller having:
i) a material handling mode for transporting loads on the platform of the mobile base; and
ii) a security mode wherein at least one of the drones is deployed to conduct surveillance using the drone sensor.

2. The material handling robot of claim 1, wherein the drone sensor includes a thermal camera and an optical camera.

3. The material handling robot of claim 2, wherein the thermal camera is activated during the material handling mode to detect temperature increases on warehouse equipment, and generate an alert for preventative maintenance based on the temperature increases.

4. The material handling robot of claim 1, wherein each docking station includes a magnetic coupling for holding the drone on the docking station.

5. The material handling robot of claim 4, wherein the magnetic coupling is an electromagnet, and wherein the electromagnet is activated while the power charger is recharging the power source of the drone.

6. The material handling robot of claim 4, wherein the launch mechanism has a spring-loaded launcher, and the magnetic coupling compresses the spring-loaded launcher when the drone is docked.

7. The material handling robot of claim 6, wherein the spring-loaded launcher comprises a compressed air piston.

8. The material handling robot of claim 1, wherein the power charger includes a wireless fast charger.

9. The material handling robot of claim 1, wherein each drone is a quadcopter.

10. The material handling robot of claim 9, wherein the controller operates a nano-network for selectively deploying one of the drones based on a specific task, and power requirements for the specific task.
